(19) United States
(12) Patent Application Publication
(10) Pub. No.: US 2013/0113671 A1
(43) Pub. Date: May 9, 2013

(54) SLOT ANTENNA

(71) Applicants: Wei-Cheng SU, Taipei City (TW); Cheng-Wen WANG, Taipei City (TW)

(72) Inventors: Wei-Cheng SU, Taipei City (TW); Cheng-Wen WANG, Taipei City (TW)

(21) Appl. No.: 13/433,032

(22) Filed: Mar. 28, 2012

(30) Foreign Application Priority Data
Nov. 3, 2011 (TW) 100140149

(51) Int. Cl. H01Q 13/10

(52) U.S. Cl. 343/767

(57) ABSTRACT

A slot antenna includes a substrate, a coupling-feed structure, and a grounding member. The coupling-feed structure is disposed at a top surface of the substrate. The coupling-feed structure includes a first coupling member and a second coupling member. The second coupling member is separately disposed near by the first coupling member. The grounding member is electrically connected to a bottom surface of the substrate and has a slot. A portion of the slot is disposed under the first coupling member and the second coupling member.

### RELATED APPLICATIONS

This application claims priority to Taiwan Application Serial Number 100140149, filed Nov. 3, 2011, which is herein incorporated by reference.

### BACKGROUND

1. Field of Invention

The present invention relates to a slot antenna, and more particularly, to a slot antenna with a miniaturized slot.

2. Description of Related Art

An antenna is a coupling component or a conductive system that is capable of performing an electromagnetic energy conversion in circuits. For example, the antenna converts electrical energy of a wireless signal at an operation frequency into electromagnetic energy for radiating the wireless signal to surrounding environment while transmitting the wireless signal, and the antenna converts electromagnetic energy of a wireless signal at the operation frequency into electrical energy for providing the wireless signal to a processor. In general, the characteristics and the performance of an antenna can be determined by the parameters such as radiation pattern, return loss, antenna gain, etc.

Because different communication products may have different operation frequencies and required functions, the antennas used for radiating or receiving signals have diversified designs, such as a dipole antenna, a monopole antenna, a traveling-wave wire antenna, a helical antenna, a spiral antenna, a ring antenna, a microstrip antenna, a printed antenna, etc. In order to obtain a good coverage above a horizontal plane in a wireless network application, a dipole antenna is generally used in a product to obtain an omni-directional radiation pattern. However, the dipole antenna will protrude outwards from the product, which increases product volume and design difficulty. Owing to having advantages of small volume, lightweight, low cost, and easy manufacture, the microstrip antenna is worthy to be adopted for further reducing product size. There exist several feed-in methods for the current microstrip antenna, such as a coaxial cable-feed method, a microstrip-feed method, a coplanar waveguide (CPW)-feed, etc. In order to increase the effective bandwidth of the microstrip antenna, another conventional feed-in method is a slot-coupling method.

However, because the slot of the conventional closed-loop slot antenna required ½ of the operation wavelength of wireless signal, the slot occupies relatively large grounding space, and the closed-loop slot antenna is not suitable for use in a portable mobile communication device. Although the required resonant length of the slot for a conventional open-loop slot antenna can be reduced to be ¼ of the wavelength of the operation wireless signal, yet the open-loop slot antenna is gradually becoming inadequate for the miniaturization trend of the current electronic products. Therefore, it is important to develop the techniques for enabling a slot antenna that have a shorter resonant length.

### SUMMARY

In order to solve the problems of the prior art, the invention provides an improved slot antenna. The slot antenna uses a coupling-feed structure to stimulate a resonant pattern of the slot antenna, so as to achieve the purpose of reducing the required resonant length of a slot of the slot antenna to be ⅛ of the wavelength of a wireless signal. In addition, the equivalent capacitive reactance or the inductive reactance of the slot antenna can be adjusted by tuning the geometric dimensions of the coupling-feed structure, so that the slot antenna can obtain required radiation characteristics. Then, a second coupling member of the coupling-feed structure is grounded, which is equivalent to implanting a ground inductance, which can be used for compensating the high capacitive reactance characteristic when the length of the slot is shorter than its natural resonant length, so as to reduce the length of the slot. Furthermore, when the slot antenna of the invention is used in a common electronic apparatus, the slot of the slot antenna can be directly formed on a metal cover of the electronic apparatus, so as to obtain the advantage of omitting antenna radiation clearance zone. Moreover, the equivalent capacitance of the coupling-feed structure of the invention that is realized by microstrip line, so as to save the cost of disposing a real capacitance.

According to an embodiment of the invention, a slot antenna is used for transmitting a wireless signal. The slot antenna includes a substrate, a coupling-feed structure, and grounding member. The substrate has a top surface and a bottom surface. The coupling-feed structure is disposed at the top surface. The coupling-feed structure includes a first coupling member and a second coupling member. The second coupling member is separately disposed near by the first coupling member. The grounding member is electrically connected to the bottom surface and has a slot. A portion of the slot is disposed under the first coupling member and the second coupling member.

In an embodiment of the invention, the first coupling member includes a first coupling portion. The second coupling member includes a second coupling portion. The first coupling portion and the second coupling portion are parallel disposed on the top surface side by side substantially along a first direction.

In an embodiment of the invention, the slot is close-shaped. The slot has a length along a second direction that is perpendicular to the first direction. The length is ½ or ¼ of the wavelength of the wireless signal.

In an embodiment of the invention, the slot is open-shaped. The slot has a length along a second direction that is perpendicular to the first direction. The length is ⅛ of the wavelength of the wireless signal.

In an embodiment of the invention, the slot has an opening. The width of the slot along the first direction is gradually expanded towards a direction away from the opening.

In an embodiment of the invention, the second coupling member further includes a bent portion connected to the second coupling portion. The first coupling portion and the bent portion are spaced at a first width along the first direction. The capacitive reactance of the coupling-feed structure can be adjusted by tuning the first width.

In an embodiment of the invention, the first coupling portion has a second width. The inductive reactance of the coupling-feed structure can be adjusted by tuning the second width.

In an embodiment of the invention, the first coupling portion and the second coupling portion are spaced at a third width along a second direction.

The capacitive reactance of the coupling-feed structure can be adjusted by tuning the third width.

In an embodiment of the invention, the first coupling portion is located at an edge of the top surface.

In an embodiment of the invention, the substrate has a via hole adjacent to one end of the second coupling member that is located away from the first coupling member. The second coupling member is electrically connected to the grounding member by the via hole.

In an embodiment of the invention, the second coupling member has a is short-circuit point. The second coupling member is electrically connected to the grounding member at the short-circuit point by the via hole.

In an embodiment of the invention, the first coupling member further includes a feed-in portion electrically connected to the first coupling portion.

In an embodiment of the invention, the feed-in portion is a microstrip line or a coaxial cable.

In an embodiment of the invention, the slot is L-shaped.

In an embodiment of the invention, the slot is U-shaped.

In an embodiment of the invention, the grounding member is a metal cover of an electronic apparatus.

In an embodiment of the invention, the slot is a sound hole of the metal cover.

In an embodiment of the invention, the metal cover has a logo, and the slot is a portion of the logo.

In an embodiment of the invention, the substrate is a printed circuit board or a flexible printed circuit board.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a top view of a slot antenna according to an embodiment of the invention;

FIG. 1B is a side view of the slot antenna in FIG. 1A;

FIG. 2 is an enlarged view of the coupling-feed structure in FIG. 1A;

FIG. 3A is a partial top view of another example of the slot antenna in FIG. 1A;

FIG. 3B is a partial top view of another example of the slot antenna in FIG. 1A;

FIG. 3C is a partial top view of another example of the slot antenna in FIG. 1A;

FIG. 3D is a partial top view of another example of the slot antenna in FIG. 1A; and

FIG. 4 is a partial cross-sectional view of the slot antenna in FIG. 1A applied in an electronic apparatus.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

An improved slot antenna is provided. Specifically, the slot antenna uses a coupling-feed structure to stimulate the resonant pattern of the slot antenna, so as to achieve the purpose of reducing the required resonant length of a slot of the slot antenna to be ⅛ of the wavelength of a wireless signal. In is addition, the equivalent capacitive reactance or the inductive reactance of the slot antenna can be adjusted by tuning the geometric dimensions of the coupling-feed structure, so that the slot antenna can obtain required radiation characteristics. Then, a second coupling member of the coupling-feed structure is grounded, which is equivalent to implanting a ground inductance, thereby compensating the high capacitive reactance characteristic when the length of the slot is shorter than its natural resonant length, so as to reduce the length of the slot. Furthermore, when the slot antenna of the invention is used in a common electronic apparatus, the slot of the slot antenna can be directly formed on the metal cover of the electronic apparatus, so as to obtain the advantage of omitting antenna radiation clearance zone. Moreover, the equivalent capacitance of the coupling-feed structure of the invention that is realized by microstrip line, so as to save the cost of disposing a physical capacitance.

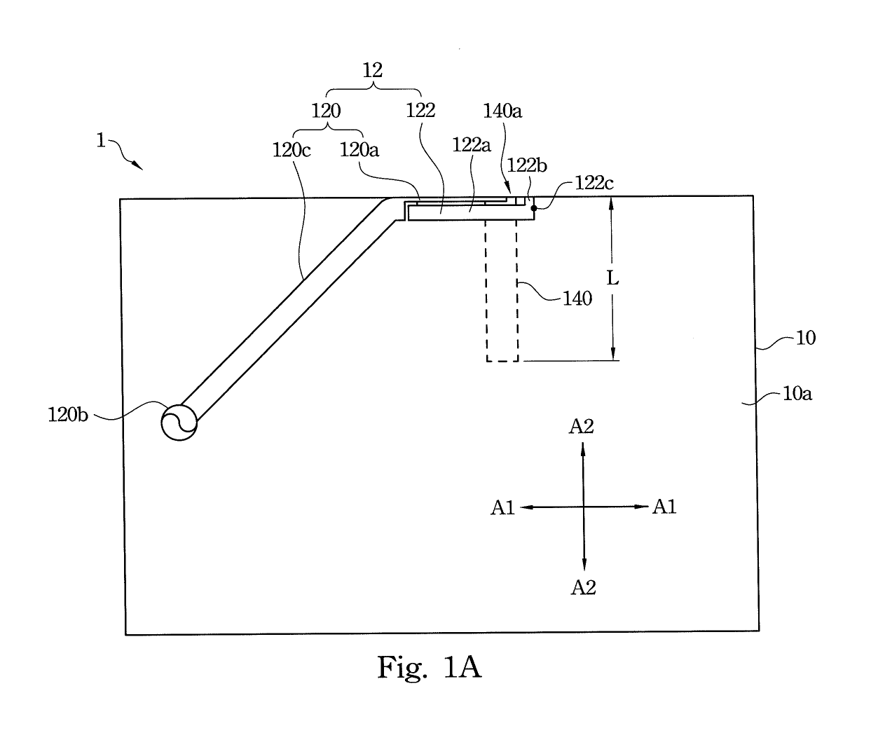

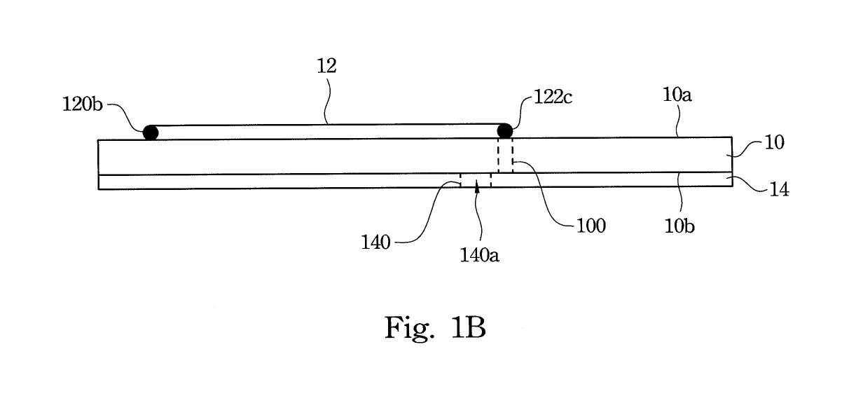

FIG. 1A is a top view of a slot antenna 1 according to an embodiment of the invention. FIG. 1B is a side view of the slot antenna 1 in FIG. 1A.

As shown in FIG. 1A and FIG. 1B, the slot antenna 1 of the invention can be applied in a computer device (such as a personal computer, a notebook computer, a tablet computer, etc.) or a consumer electronic product (such as a mobile phone, an interphone, etc.), but the invention is not limited thereto. That is, the slot antenna 1 of the invention can be applied in any electronic product that has a radio transceiver function. As long as there is a requirement to reduce the volume of the electronic product or the size of the antenna thereof, the concepts of a slot 140 of the slot antenna 1 of the invention can be applied to achieve the purpose of miniaturization.

As shown in FIG. 1A and FIG. 1B, the slot antenna 1 can transmit a wireless signal with a certain frequency.

The slot antenna 1 includes a substrate 10, a coupling-feed structure 12, and a grounding member 14. The substrate 10 of the slot antenna 1 can be a printed circuit board made of a FR4 glass fiber plate, a FRP glass fiber plate, or a ceramic substrate, or a flexible printed circuit board, but the invention is not limited thereto. The substrate 10 of the slot antenna 1 has a top surface 10a and a bottom surface 10b. The coupling-feed structure 12 of the slot antenna 1 is disposed at the top surface 10a of the substrate 10. The coupling-feed structure 12 of the slot antenna 1 includes a first coupling member 120 and a second coupling member 122. The second coupling member 122 of the coupling-feed structure 12 is separately disposed near by the first coupling member 120. The grounding member 14 of the slot antenna 1 is electrically connected to the bottom surface 10b of the substrate 10 and has the slot 140. A portion of the slot 140 of the grounding member 14 is disposed under the first coupling member 120 and the second coupling member 122 of the coupling-feed structure 12.

As shown in FIG. 1A, the first coupling member 120 of the coupling-feed structure 12 includes a strip-shaped first coupling portion 120a, and the second coupling member 122 includes a strip-shaped second coupling portion 122a. The first coupling portion 120a of the first coupling member 120 and the second coupling portion 122a of the second coupling member 122 are parallel disposed on the top surface 10a of the substrate 10 side by side substantially along a first direction A1. In the embodiment, the slot 140 of the grounding member 14 is an open-loop slot, and thus has an opening 140a. The slot 140 of the grounding member 14 has a length L along a second direction A2 that is perpendicular to the first direction A1. In the invention, the coupling-feed structure 12 and the slot 140 are disposed respectively at the top surface 10a and the bottom surface 10b of the substrate 10 and are partially overlapped, and the equivalent capacitance and the equivalent inductance of the coupling-feed structure 12 are used to compensate the originally required length of the slot 140, thereby achieving the purpose of reducing the required length L of the slot 140 from ¼ of the wavelength of a wireless signal radiated by the slot antenna 1 to ⅛ of the wavelength of the wireless signal.

However, the coupling-feed structure 12 of the invention is not limited to being merely used in the slot antenna 1 having the open-loop slot 140. In an embodiment, the slot 140 of the grounding member 14 can also be closed-loop. According to the principals of slot antenna, the required length of the closed-loop slot of the slot antenna is ½ of the wavelength of the wireless signal radiated by the slot antenna.

As shown in FIG. 1A, the first coupling portion 120a of the first coupling member 120 is located at the edge of the top surface 10a of the substrate 10. The closer the coupling-feed structure 12 is located relative to the edge of the substrate 10, the slot antenna 1 can obtain better radiation performance. Practically, the coupling-feed structure 12 of the slot antenna 1 is not necessary to be located at the edge of the substrate 10. Instead, the distance of the coupling-feed structure 12 relative to the edge of the substrate 1 can be flexibly modified according to design requirements (for example, according to the layout matching other circuit components on the substrate 10) or manufacture limitations (such as space management).

As shown in FIG. 1B, the substrate 10 of the slot antenna 1 has a via hole 100. The via hole 100 of the substrate 10 is located adjacent to one end of the second coupling member 122 that is located away from the first coupling member 120. The second coupling member 122 is electrically connected to the grounding member 14 that is located at the bottom surface 10b of the substrate 10 by the via hole 100. When the length of the slot 140 of the slot antenna 1 is shorter than its natural resonant length (i.e., ½ of the wavelength corresponding to the operation frequency of the slot antenna 1), the characteristic impedance of the slot antenna 1 will show high capacitive reactance characteristic. In order to compensate the high capacitive reactance characteristic, the second coupling member 122 of the coupling-feed structure 12 of the embodiment is grounded, which is equivalent to implanting a ground inductance.

As shown in FIG. 1A and FIG. 1B, the first coupling member 120 of the coupling-feed structure 12 further includes a feed-in portion 120c electrically connected to the first coupling portion 120a. The feed-in portion 120c has a feed-in point 120b, and the second coupling member 122 has a short-circuit point 122c. The feed-in point 120c of the first coupling member 120 and the short-circuit point 122c of the second coupling member 122 are respectively disposed at two sides of the slot 140 of the grounding member 14, and the short-circuit point 122c of the second coupling member 122 is electrically connected to the grounding member 14 by the via hole 100 of the substrate 10.

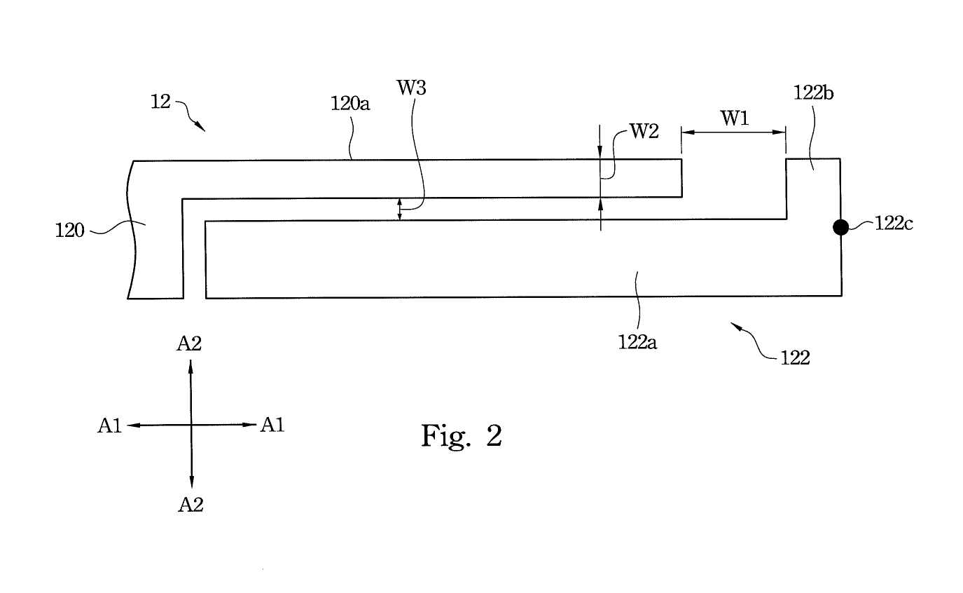

FIG. 2 is an enlarged view of the coupling-feed structure 12 in FIG. 1A. As shown in FIG. 2, the second coupling member 122 of the coupling-feed structure 12 further includes a bent portion 122b. The bent portion 122b of the second coupling member 122 is connected to one end of the second coupling portion 122a that is located away from the first coupling member 120. The bent portion 122b of the second coupling member 122 is bent substantially along the second direction A2 (i.e., the bending portion 122b can be bent to be parallel or unparallel to the second direction A2), and one end of the first coupling portion 120a is aligned with the bent portion 122b of the second coupling member 122. Therefore, the end the first coupling portion 120a and the bent portion 122b of the second coupling member 122 are spaced at a first width W1. Because the coupling-feed structure 12 forms an equivalent capacitance with the first coupling portion 120a of the first coupling member 120 and the second coupling portion 122a of the second coupling member 122, the overlapping region between the first coupling portion 120a and the second coupling portion 122a along the first direction A1 will affect the overall capacitive reactance of the coupling-feed structure 12. In other words, the capacitive reactance of the equivalent capacitance formed by the coupling-feed structure 12 of the invention can be adjusted by tuning the first width W1 between the end of the first coupling portion 120a and the bent portion 122b of the second coupling member 122. When the first width W1 becomes smaller, representing that the overlapping region between the first coupling portion 120a and the second coupling portion 122a becomes larger (i.e., the capacitance becomes larger), the capacitive reactance of the equivalent capacitance formed by the coupling-feed structure 12 will become smaller, so that the operation frequency of the slot antenna 1 will become lower. Correspondingly, when the first width W1 becomes larger, representing that the overlapping region between the first coupling portion 120a and the second is coupling portion 122a becomes smaller (i.e., the capacitance becomes smaller), the capacitive reactance of the equivalent capacitance formed by the coupling-feed structure 12 will become larger, so that the operation frequency of the slot antenna 1 will become higher.

In the embodiment, the first coupling portion 120a of the first coupling member 120 has a second width W2. The second width W2 of the first coupling portion 120a will affect the overall inductive reactance of the coupling-feed structure 12. In other words, the inductive reactance of the coupling-feed structure 12 of the invention can be adjusted by tuning the second width W2 of the first coupling portion 120a. When the second width W2 becomes smaller, representing that the inductance of the coupling-feed structure 12 becomes larger, the operation frequency of the slot antenna 1 will become lower. Correspondingly, when the second width W2 becomes larger, representing that the inductance of the coupling-feed structure 12 becomes smaller, the operation frequency of the slot antenna 1 will become higher.

Furthermore, in the embodiment, the first coupling portion 120a and the second coupling portion 122a are spaced at a third width W3 along the second direction A2. The overall capacitive reactance of the coupling-feed structure 12 can be adjusted by tuning the third width W3. When the third width W3 becomes smaller, representing that the distance between the first coupling to portion 120a and the second coupling portion 122a becomes smaller (i.e., the capacitance becomes larger), the capacitive reactance of the equivalent capacitance formed by the coupling-feed structure 12 will become smaller, so that the operation frequency of the slot antenna 1 will become lower. Correspondingly, when the third width W3 becomes larger, representing that the distance between the first coupling portion 120a and the second coupling portion 122a becomes larger (i.e., the capacitance becomes smaller), the capacitive reactance of the equivalent capacitance formed by the coupling-feed structure 12 will become larger, so that the operation frequency of the slot antenna 1 will become higher.

In the embodiment, the feed-in portion 120c of the coupling-feed structure 12 can be a microstrip line or a coaxial cable, but the invention is not limited thereto.

To sum up, the invention can adjust the capacitive reactance and the inductive reactance of the slot antenna 1 by tuning the first width W1 between the end of the first coupling portion 120a and the bent portion 122b of the second coupling member 122, the second width W2 of the first coupling portion 120a, and the third width W3 between the first coupling portion 120a and the second coupling portion 122a. Not only the operation frequency of the slot antenna 1 can be adjusted to match the impedance for operation under expected radiation characteristics, but also the originally required length of the slot 140 can be compensated by the equivalent capacitance and the equivalent inductance formed by the coupling-feed structure 12. Furthermore, a second coupling member 122 of the coupling-feed structure 12 is grounded, which is equivalent to implanting a ground inductance, thereby compensating the high capacitive reactance characteristic when the length of the slot 140 is shorter than its natural resonant length, so as to reduce the length of the slot 140 and achieve the purpose of reducing the required length L of the slot 140 to ⅛ of the wavelength of the wireless signal.

For example, the corresponding wavelength of a 2.46 GHz slot antenna is fabricated on the FR4 substrate (thickness=0.8 mm, dielectric constant=4.4) is 74 mm, thus, the length of the slot that is ⅛ of the wavelength is about 9.25 mm.

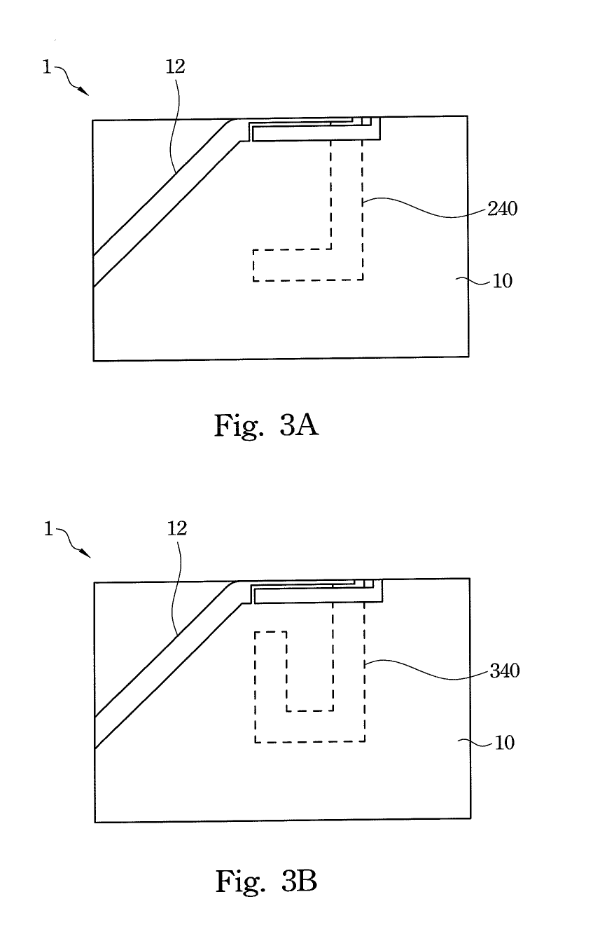

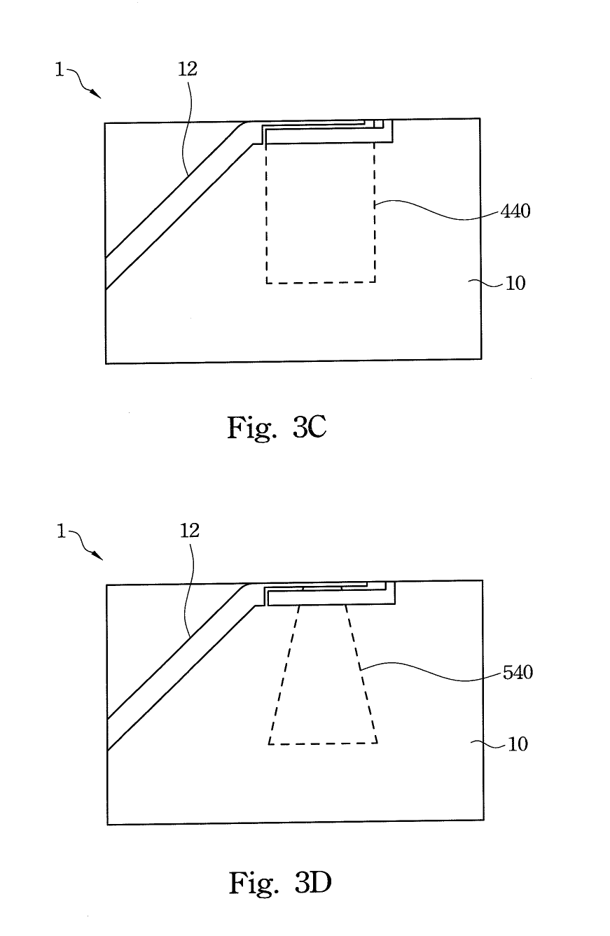

FIG. 3A is a partial top view of another example of the slot antenna 1 in FIG. 1A. FIG. 3B is a partial top view of another example of the slot antenna 1 in FIG. 1A. FIG. 3C is a partial top view of another example of the slot antenna 1 in FIG. 1A. FIG. 3D is a partial top view of another example of the slot antenna 1 in FIG. 1A.

The slot 140 of the grounding member 14 in FIG. 1 can be changed to be a L-shaped slot 240 as shown in FIG. 3A. The slot 140 of the grounding member 14 in FIG. 1 can be changed to be a U-shaped slot 340 as shown in FIG. 3B. The slot 140 of the grounding member 14 in FIG. 1 can be changed to be a slot 440 of which the width along the first direction A1 is gradually expanded towards a direction away from the opening 140a (i.e., away from the edge of the substrate 10) as shown in FIG. 3C. But the invention is not limited thereto, as long as the designing principals related to the slot antenna 1 introduced above can be met, the shape of the slot 140 of the grounding member 14 can be modified according to design requirements (e.g., aesthetic feeling) or manufacturing limitations (e.g., space management).

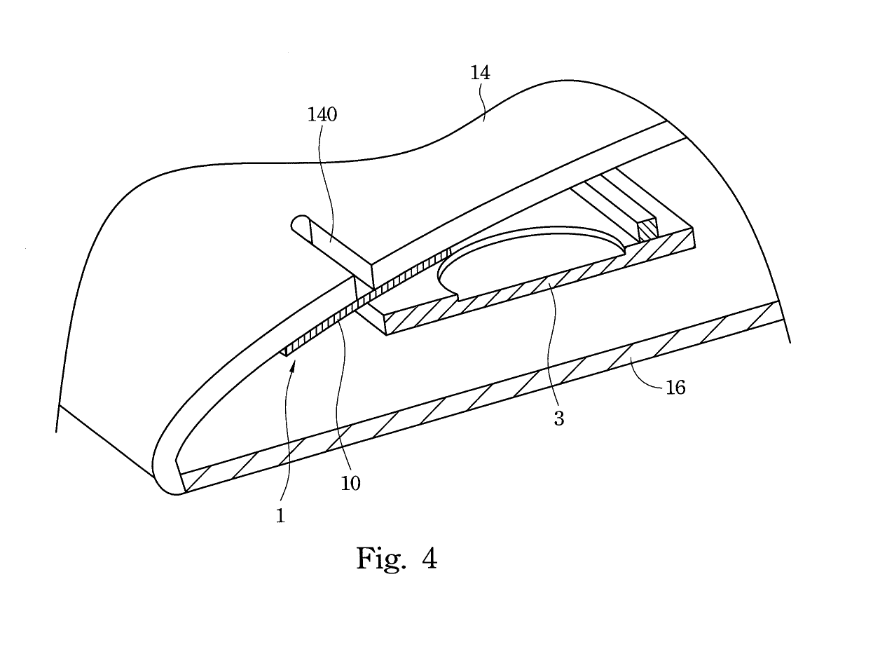

FIG. 4 is a partial cross-sectional view of the slot antenna 1 in FIG. 1A applied in an electronic apparatus.

As shown in FIG. 4, the slot antenna 1 of the invention can be used in an electronic apparatus. The electronic apparatus includes a metal cover and a front cover 16. Therefore, the metal cover of the electronic apparatus can be directly used as the grounding member 14 of the slot antenna 1 and needn't another conductive metal plate used as the grounding member 14. In the embodiment, the electronic apparatus further includes a speaker 3 disposed between the metal cover and the front cover 16. A sound hole on the metal cover can be used as the slot 140 of the slot antenna 1 and for application of the speaker 3.

Furthermore, if the electronic apparatus has a logo on the metal cover, the slot 140 of the slot antenna 1 can also be used as a portion of the logo. For example, if the logo of a D company includes a letter L, the slot 140 of the slot antenna 1 can be manufactured to be L-shaped and thus becomes a portion of the logo.

According to the foregoing recitations of the embodiments of the invention, it can be seen that the slot antenna uses a coupling-feed structure to stimulate the resonant pattern of the slot antenna, so as to achieve the purpose of reducing the required resonant length of a slot of the slot antenna to be ⅛ of the wavelength of a wireless signal. In addition, the equivalent capacitive reactance or the inductive reactance of the slot antenna can be adjusted by tuning the geometric dimensions of the coupling-feed structure, so that the slot antenna can obtain required radiation characteristics. Then, a second coupling member of the coupling-feed structure is grounded, which is equivalent to implanting a ground inductance, thereby compensating the high capacitive reactance characteristic when the length of the slot is shorter than its natural resonant length, so as to reduce the length of the slot. Furthermore, when the slot antenna of the invention is used in a common electronic apparatus, the slot of the slot antenna can be directly formed on the metal cover of the electronic apparatus, so as to obtain the advantage of omitting antenna radiation clearance zone. Moreover, the equivalent capacitance of the coupling-feed structure of the invention that is realized by microstrip line, so as to save the cost of disposing a physical capacitance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A slot antenna for transmitting a wireless signal, the slot antenna comprising:
a substrate having a top surface and a bottom surface;
a coupling-feed structure disposed at the top surface, the coupling-feed structure comprising:
a first coupling member; and
a second coupling member separately disposed near by the first coupling member; and
a grounding member electrically connected to the bottom surface and having a slot, wherein a portion of the slot is disposed under the first coupling member and the second coupling member.

2. The slot antenna of claim 1, wherein the first coupling member comprises a first coupling portion, and the second coupling member comprises a second coupling portion, and the first coupling portion and the second coupling portion are parallel disposed on the top surface side by side substantially along a first direction.

3. The slot antenna of claim 2, wherein the slot is close-shaped, and the slot has a length along a second direction that is perpendicular to the first direction, and the length is ½ or ¼ of the wavelength of the wireless signal.

4. The slot antenna of claim 2, wherein the slot is open-shaped, and the slot has a length along a second direction that is perpendicular to the first direction, and the length is ⅛ of the wavelength of the wireless signal.

5. The slot antenna of claim 4, wherein the slot has an opening, and a width of the slot along the first direction is gradually expanded towards a direction away from the opening.

6. The slot antenna of claim 2, wherein the second coupling member further comprises a bent portion connected to the second coupling portion, and the first coupling portion and the bending portion are spaced at a first width along the first direction, and the capacitive reactance of the coupling-feed structure is adjusted by tuning the first width.

7. The slot antenna of claim 2, wherein the first coupling portion has a second width, and the inductive reactance of the coupling-feed structure is adjusted by tuning the second width.

8. The slot antenna of claim 2, wherein the first coupling portion and the second coupling portion are spaced at a third width along a second direction, and the capacitive reactance of the coupling-feed structure is adjusted by tuning the third width.

9. The slot antenna of claim 2, wherein the first coupling portion is located at an edge of the top surface.

10. The slot antenna of claim 1, wherein the substrate has a via hole adjacent to one end of the second coupling member that is located away from the first coupling member, and the second coupling member is electrically connected to the grounding member by the via hole.

11. The slot antenna of claim 10, wherein the second coupling member has a short-circuit point, and the second coupling member is electrically connected to the grounding member at the short-circuit point by the via hole.

12. The slot antenna of claim 2, wherein the first coupling member further comprises a feed-in portion electrically connected to the first coupling portion.

13. The slot antenna of claim 12, wherein the feed-in portion is a microstrip line or a coaxial cable.

14. The slot antenna of claim 1, wherein the slot is L-shaped.

15. The slot antenna of claim 1, wherein the slot is U-shaped.

16. The slot antenna of claim 1, wherein the grounding member is a metal cover of an electronic apparatus.

17. The slot antenna of claim 16, wherein the slot is a sound hole of the metal cover.

18. The slot antenna of claim 16, wherein the metal cover has a logo, and the slot is a portion of the logo.

19. The slot antenna of claim 1, wherein the substrate is a printed circuit board or a flexible printed circuit board.
